(19) United States
(12) Patent Application Publication
(10) Pub. No.: US 2016/0060506 A1
(43) Pub. Date: Mar. 3, 2016

(54) INJECTION MATERIAL FOR FRACTURING AND FLUID FOR FRACTURING

(71) Applicant: SHOWA DENKO K.K., Tokyo (JP)

(72) Inventors: Kei TAKAHASHI, Minato-ku, Tokyo (JP); Makoto SAITO, Minato-ku, Tokyo (JP)

(73) Assignee: SHOWA DENKO K.K., Minato-ku, Tokyo (JP)

(21) Appl. No.: 14/781,751

(22) PCT Filed: Feb. 21, 2014
(86) PCT No.: PCT/JP2014/054222

§ 371 Date: Oct. 1, 2015

(30) Foreign Application Priority Data
Apr. 5, 2013 (JP) 2013-079525

(51) Int. Cl. C09K 8/68

(52) U.S. Cl. CPC C09K 8/68

(57) ABSTRACT

The present invention provides a fracturing fluid with a high level of safety, excellent dispersion stability of a fluid and a fracture support material, and a short-term degradability, and an injection material for fracturing to be contained in the fracturing fluid. The injection material for fracturing includes a resin composition at least containing a hydrolyzable or biodegradable resin and a starch. The fracturing fluid includes the injection material for fracturing, a support material with an average particle size of from 0.1 to 3 mm, and water.

### TECHNICAL FIELD

The present invention relates to a fracturing fluid used for fracturing in shale gas wells and the like and an injection material for fracturing to be contained in the fracturing fluid.

### BACKGROUND ART

Shale gas is a natural gas extracted from base rock layers such as shale layers, which is called a non-conventional natural gas because produced from places other than conventional gas wells. Shale gas reservoirs have a huge amount of original gas in place but had had a low productivity until the 1990s. However, hydraulic fracturing technology and horizontal borehole technology have been established to tremendously improve the productivity and draw attention to shale gas in recent years.

Since shale has a low permeability, fractures (cracks) for gas extraction are required to be artificially generated to produce a commercial amount of the gas. In hydraulic fracturing method, a vertical borehole is bored and turned to a horizontal direction at the halfway point, and the horizontal borehole is bored along a shale layer deep underground. Then, fracturing fluid is injected to the borehole under a pressure to generate fractures, and the proppant (support material, i.e., special sand particles) is slided into the fractures to support them. This can prevent the fractures from closing to allow the continuous extraction.

Tight oil is a non-conventional crude oil extracted from shale layers and the like, which can be obtained in the same manner as shale gas.

As described above, fracturing fluid has been used in the production of non-conventional natural resources such as shale gas and tight oil. Fracturing fluid contains about 90% of water with the rest containing a few percent of proppant and other chemicals such as resins, antiseptics, gelators, and friction reducers.

Since conventional technologies are at risk from environmental pollution especially caused by water discharged to underground after hydraulic fracturing, fracturing fluid not causing environmental pollution has been demanded.

Patent Document 1 discloses a degradable particles such as aliphatic polyester particles and a method of producing slurry thereof and a method of using the degradable particle in the hydraulic fracturing of extraction layers deep underground. However, the degradable particles are required to be dissolved in organic solvent and to be used with a surfactant, and thus have an impact on the environment.

Patent Document 2 discloses a fracturing fluid containing a biodegradable natural polysaccharide solution with a specific viscosity and a support material with a particle size of from 0.1 to 2.8 mm. However, the dispersion stability and the like are insufficient.

Patent Document 3 discloses a method of injecting a fracturing fluid containing solid particles formed of a degradable substance and describes aliphatic polyester, polylactic acid, polyglycol acid and the like as hydrolyzable or biodegradable resin substances. However, the method has difficulty of regulating the degradation and thus comes with a practical problem.

Under these circumstances, the development of fracturing fluid with a high level of safety, excellent dispersion stability, and short-term degradability has been demanded.

### CITATION LIST

### Patent Literature

### Patent Document 1: JP 2009-114448 A

### Patent Document 2: JP 2012-162919 A

### Patent Document 3: WO2012/104582 A1

### SUMMARY OF INVENTION

### Technical Problem

An objective of the present invention is to provide a fracturing fluid with a high level of safety, excellent dispersion stability, and short-term degradability, and an injection material for fracturing to be contained in the fracturing fluid.

### Solution to Problem

The present invention provides the following [1] to [10].

[1] An injection material for fracturing including a resin composition at least containing a hydrolyzable or biodegradable resin and a starch.

[2] The injection material for fracturing according to [1], in which the starch is oxidized starch.

[3] The injection material for fracturing according to [1] or [2], in which the hydrolyzable or biodegradable resin is one or more selected from polybutylene succinate, polybutylene succinate-adipate, polybutylene adipate-terephthalate, and polylactic acid.

[4] The injection material for fracturing according to any one of [1] to [3], in which the injection material for fracturing is a pulverized material formed from a formed product of the resin composition containing a hydrolyzable or biodegradable resin and a starch.

[5] The injection material for fracturing according to any one of [1] to [3], in which the resin composition forms a particle with an average particle size of 1 mm or less.

[6] The injection material for fracturing according to [4], in which the pulverized material formed from the formed product is a microfilm with a thickness of from 5 to 200 μm.

[7] The injection material for fracturing according to [6], in which the microfilm is a fraction passed through a sieve with an opening of from 0.5 to 15 mm.

[8] The injection material for fracturing according to [6] or [7], in which the aspect ratio (longitudinal length/lateral length) of the microfilm is 4 or more.

[9] The injection material for fracturing according to any one of [1] to [8], in which the amount of the starch is from 5 to 90 mass % based on the total amount of the hydrolyzable or biodegradable resin and the starch.

[10] A fracturing fluid including the injection material for fracturing according to any one of [1] to [9], a fracture support material with an average particle size of from 0.1 to 3 mm, and water.

### Advantageous Effects of Invention

The present invention can provide a fracturing fluid with a high level of safety, excellent dispersion stability, and short-term degradability and also provide an injection material for fracturing to be contained in the fracturing fluid.

### DESCRIPTION OF EMBODIMENTS

### Injection Material for Fracturing

The injection material for fracturing of the present invention is blend with a fracture support material in a fracturing fluid, which at least contains a hydrolyzable or biodegradable resin and a starch. The injection material for fracturing improves the dispersibility of the fracture support material and help deliver the fracturing fluid.

### <Hydrolyzable or Biodegradable Resin>

In the present invention, the hydrolyzable or biodegradable resin is used by mixing with a starch.

The “hydrolyzable or biodegradable resin” in the present invention includes not only degradable resin by chemically (nonenzymatically) hydrolysis but also degradable resin by microorganisms. The “hydrolyzable or biodegradable resin” is hereinafter merely referred to as “degradable resin”.

Such a degradable resin is preferably (1) a polycondensed aliphatic polyester, (2) an aliphatic-aromatic polyester, (3) a polylactic acid, (4) a polycaprolactone, or the like. As the other degradable resin, cellulose acetate, a polyhydroxybutyrate-valerate copolymer produced by microorganisms, or the like can also be used. These resins can be used one kind alone or in combination with two or more kinds.

### (1) Polycondensed Aliphatic Polyester

The polycondensed aliphatic polyester preferably has an extended structure via urethane linkages, which is synthesized from polyhydric alcohol and aliphatic polycarboxylic acid (see JP 05-70575 A, JP 06-248104 A, etc.).

Examples of the polyhydric alcohol include chain alcohols such as ethylene glycol, 1,4-butanediol, 1,6-hexanediol, decamethylene glycol, and neopentyl glycol; and a cyclic alcohol such as 1,4-cyclohexane dimethanol. Examples of the aliphatic polycarboxylic acid include succinic acid, adipic acid, suberic acid, sebacic acid, dodecanoic diacid, and anhydrates thereof.

In the present invention, a condensation polymer of ethylene glycol and/or 1,4-butanediol with succinic acid and/or adipic acid is preferably used as the aliphatic polyester. In addition to the above-mentioned components, the polycondensed aliphatic polyester may contain polyol, oxycarboxylic acid, polycarboxylic acid, and the like with three or four functional groups as a copolymerized component.

Preferred examples of the polycondensed aliphatic polyester include poly butylene succinate and polybutylene succinate-adipate. As the commercial product of such an aliphatic polyester, “Bionolle” (a trademark) series available from Showa Denko K. K. can preferably be used.

### (2) Aliphatic-Aromatic Polyester

The aliphatic-aromatic polyester means a polymer obtained by polycondensing one or more glycols with one or more aromatic dicarboxylic acids and one or more aliphatic dicarboxylic acids. Particularly, a thermoplastic aliphatic-aromatic polyester is preferable in terms of formability.

Examples of the glycols include ethylene glycol, propylene glycol, 1,3-propanediol, 1,4-butanediol, neopentyl glycol, 1,6-hexanediol, decamethylene glycol, and polymeric glycols such as polyoxyethylene glycol, polyoxypropylene glycol, and polyoxytetramethylene glycol and copolymers thereof.

Examples of the aromatic dicarboxylic acids include terephthalic acid and isophthalic acid.

Examples of the aliphatic dicarboxylic acids include succinic acid, adipic acid, suberic acid, azelaic acid, sebacic acid, 1,10-decanedicarboxylic acid, 1,12-dodecanedicarboxylic acid, 1,16-hexadecanedicarboxylic acid, 1,18-octadecanedicarboxylic acid, and fumaric acid.

The aliphatic-aromatic polyester preferably contains an acid component containing typically from 20 to 95 mol %, preferably from 30 to 70 mol %, more preferably from 40 to 60 mol % of an aliphatic dicarboxylic acid component and typically from 80 to 5 mol %, preferably from 70 to 30 mol %, more preferably from 60 to 40 mol % of an aromatic dicarboxylic acid component; and an aliphatic glycol component. The amount of the aliphatic glycol component is substantially equal to the total amount by mole of the aliphatic dicarboxylic acid component and the aromatic dicarboxylic acid component, and may contain a linkage group typified by an isothiocyanate group so as to increase the molecular weight of the resultant aliphatic-aromatic polyester.

Examples of the aliphatic-aromatic polyester include polyethylene adipate-terephthalate, polybutylene adipate-terephthalate, polypropylene adipate-terephthalate, polyethylene succinate-terephthalate, polybutylene succinate-terephthalate, polyethylene sebacate-terephthalate, and polybutylene sebacate-terephthalate, but polybutylene adipate-terephthalate is preferable.

The aliphatic-aromatic polyester has a melting point within a range of preferably from 50 to 190° C., more preferably from 60 to 180° C., further more preferably from 70 to 170° C. Furthermore, the melt flow rate (MFR: ASTM D-1238, 190° C., load: 2160 g) of the aliphatic-aromatic polyester is typically from 0.1 to 100 g/10 min, preferably from 0.8 to 30 g/10 min, more preferably from 0.8 to 3 g/10 min.

The aliphatic-aromatic polyester can be produced by various known methods, for example, described in JP 2002-527644 A and JP 2001-501652 A.

Examples of the commercial product of the aliphatic-aromatic polyester include “ECOFLEX” available from BASF.

### (3) Polylactic Acid

Examples of polylactic acid include a mixture of D-lactic acid homopolymer with L-lactic acid homopolymer, a copolymer of D-lactic acid with L-lactic acid, and a mixture thereof.

The polylactic acid may also be a copolymer with another hydroxycarboxylic acid unit such as α-hydroxycarboxylic acid, a copolymer with aliphatic diol/aliphatic dicarboxylic acid, or a copolymer with nonaliphatic diol or nonaliphatic dicarboxylic acid in view of improving the film formability and the like.

Examples of the another hydroxycarboxylic acid unit include aliphatic bifunctional hydroxy-carboxylic acids such as optical isomers of lactic acid (D-lactic acid for L-lactic acid; L-lactic acid for D-lactic acid), glycol acid, 3-hydroxybutyric acid, 4-hydroxybutyric acid, 2-hydroxy-n-butyric acid, 2-hydroxy-3,3-dimethylbutyric acid, 2-hydroxy-3-methylbutyric acid, 2-methyllactic acid, and 2-hydroxycaproic acid; and lactones such as caprolactone, butyrolactone, and valerolactone.

Examples of the aliphatic diol copolymerized with polylactic acid include ethylene glycol, 1,4-butanediol, and 1,4-cyclohexanedimethanol. Examples of the nonaliphatic diol include Bisphenol A-ethylene oxide adducts.

Examples of the aliphatic dicarboxylic acid include succinic acid, adipic acid, suberic acid, sebacic acid, and dodecanedioic acid. Examples of the nonaliphatic dicarboxylic acid include terephthalic acid.

The polylactic acid preferably has both or either of L-lactic acid and D-lactic acid as a repeating unit and contains preferably 94 mol % or less, more preferably 92 mol % or less of each of L-lactic acid and D-lactic acid contents. The contents within such ranges improve the dispersibility and the like so as not to provide the polylactic acid with crystallinity.

The weight-average molecular weight of the polylactic acid is within a range of preferably from 60,000 to 600,000, more preferably from 80,000 to 400,000, further more preferably from 100,000 to 300,000, particularly preferably from 120,000 to 280,000 in terms of practical physical properties such as mechanical strength and viscosity.

Examples of the commercial products of the polylactic acid include“4060D,” “4043D,” and “4032D” available from Nature Works LLC.

### (4) Polycaprolactone

The polycaprolactone is a resin produced by ring-opening polymerizing a cyclic lactone compound such as caprolactone by use of a small amount of activated hydrogen compound as an initiator.

The weight-average molecular weight of the polycaprolactone is preferably 50,000 or more in terms of mechanical strength. More preferably, a high-molecular weight polymer with a weight-average molecular weight of 100,000 or more (see JP 07-53686 A or the like) is used as the polycaprolactone. Examples of the commercial products of the polycaprolactone include “Cel green series” such as Cel green PH7 and CBS171 available from Daicel Chemical Industries Co., Ltd., and “TONE series” such as “TONE Polymer P-767” available from Union Carbide Corporation.

The above-mentioned hydrolyzable or biodegradable resins are more preferably one or more selected from polybutylene succinate, polybutylene succinate-adipate, polybutylene adipate-terephthalate, and polylactic acid, further more preferably a combination of one or more selected from polybutylene succinate, polybutylene succinate-adipate, and polybutylene adipate-terephthalate with polylactic acid, particularly preferably a combination of polybutylene succinate-adipate with polylactic acid, in view of improving the dispersibility of a fracture support material and help deliver fracturing fluid.

### <Starch>

The starch used in the present invention may be natural or processed starch.

Examples of the natural starch include, but not particularly limited to, maize starch (cornstarch), waxy cornstarch, potato starch, tapioca starch, sago starch, sweet potato starch, rice starch, and wheat starch. Among these, in terms of availability, one or more selected from cornstarch, potato starch, and tapioca starch are preferable, and cornstarch is more preferable.

The processed starch is derived by chemically, physically, or enzymatically processing natural starch to modify the physical properties or the characteristics of the natural starch. The processed starch may be partially or fully pregelatinized but is preferably β starch in view of the less increase in the viscosity before heated and the excellent miscibility of the raw materials.

Examples of the chemical process for the natural starch include oxidation, acetylation, esterification, etherification, cationization, acetylation-oxidation, acetylated adipate cross-linking, phosphate cross-linking, aldehyde cross-linking, acrolein cross-linking, epichlorohydrin cross-linking, hydroxyethylation, hydroxyalkylation, hydroxypropylation, carboxymethylation, cyanoethylation, methylation, and octenylsuccination.

Examples of the physical process include moist-heat process, oil and fat process, hot-water process, ball-milling process, and high-pressure process.

The processed starch used in the present invention is, in view of the dispersibility of the mixture and the formability and the like, preferably a chemically processed starch, more preferably oxidized starch such as dicarboxylated starch (e.g., see JP 09-188704 A), acetylated starch, esterified starch (e.g., see JP 08-188601 A), etherified starch such as carboxymethylated starch (e.g., see JP 2000-72801 A), cationized starch obtained by processing starch with a quaternary ammonium compound such as glycidyltrimethylammonium chloride or a tertiary amino compound such as 2-dimethylaminoethyl chloride (e.g., see JP 09-12602 A), and cross-linked starch obtained by processing starch with acetaldehyde, phosphoric acid, or the like (e.g., see JP 2007-222704 A, JP 2004-204197 A), further more preferably oxidized starch, acetylated starch, esterified starch or cationized starch, particularly preferably oxidized starch.

For example, dicarboxylated starch as an oxidized starch is prepared by oxidizing starch with sodium hypochlorite, hypochlorous acid salts, bleaching powders, hydrogen peroxide, potassium permanganate, ozone, or the like.

Starch can be oxidized with sodium hypochlorite or the like, for example, by adjusting an aqueous suspension with a starch concentration of about 40 to about 50 mass %, preferably about 45 mass %, to pH from about 8 to about 11, adding an aqueous solution of sodium hypochlorite with a chloride concentration of from about 8 to about 12 mass %, preferably about 10 mass % to the aqueous suspension, and reacting this mixture at from about 40 to about 50° C. for from 1 to 2 hours. The mixture is preferably reacted with being stirred under normal pressure. After the reaction, the reactant is separated by using a centrifugal dehydrator or the like, washed, and dried to obtain an oxidized starch.

The amount of carboxylic groups in the starch can be represented by the substitution degree of carboxylation (neutralization titration method), which is preferably from 0.001 to 0.1, more preferably from 0.003 to 0.05, and further more preferably from 0.008 to 0.04.

Examples of the commercial products of the oxidized starch include “Ace A” and “Ace C” available from Oji Cornstarch Co., Ltd.

### <Preferred Aspects of Injection Material for Fracturing>

Examples of the injection material for fracturing include the following two aspects: particles with an average particle size of 1 mm or less, which are composed of a resin composition obtained by melt-kneading at least degradable resin and starch with an extruder (preferred aspect (1)) and a microfilm composed of the resin composition (preferred aspect (2)).

Preferably, in the resin composition containing a degradable resin and a starch, the degradable resin presents in a continuous phase, and the starch presents in a dispersed phase. In a degradation process of the degradable resin in a fracturing fluid, the starch in a dispersed phase is outflowed, and the surface area of the degradable resin in a continuous phase is increased, to improve the hydrolysis rate of the degradable resin. Thus, the degradation rate of the injection material for fracturing can be controlled by adjusting the content of the degradable resin and the starch.

The starch content is preferably from 5 to 90 mass %, more preferably from 10 to 60 mass %, further more preferably from 20 to 50 mass %, and the degradable resin content is preferably from 95 to 10 mass %, more preferably from 90 to 40 mass %, further more preferably from 80 to 50 mass %, based on 100 mass % of the total amount of the degradable resin and the starch. If the starch content is less than 5 mass % and the degradable resin content is more than 95 mass %, the degradable resin is degraded slowly and degradation period becomes too long, which is unpreferable. In contrast, if the starch content is more than 90 mass % and the degradable resin content is less than 10 mass %, the pellets are prepared without a problem, but the stability of the bubbles is hardly obtained during the formation of the inflation film.

(Melt-Mixing with Extruder)

The injection material for fracturing containing a degradable resin and a starch is preferably produced by melt-kneading the both components with an extruder to prepare a resin composition.

The extruder may be a single-screw extruder or a twin-screw extruder, preferably a twin-screw extruder to gelatinize and dehydrate starch, and melt-mix the gelatinized starch with the degradable resin, simultaneously.

The twin-screw extruder may be of intermeshing or a non-intermeshing, but an intermeshing twin-screw extruder is preferable in view of kneading effect. In addition, the screws may be either co-rotated or counter-rotated. To knead the resin with less friction at a low temperature by rolling action between the screws, the screws are preferably counter-rotated. However, the screws are more preferably co-rotated to sufficiently uniformly kneading and stably molding the resin without the fluctuation of extrusion.

The extruder preferably has an adequate effective screw length (screw length (L)/screw diameter (D)) to ensure sufficient amounts of preparation. The L/D is typically 28 or more, preferably 30 or more, more preferably 31 or more. Furthermore, the extruder is preferably provided with a vent for dewatering.

The above-mentioned resin composition is efficiently and preferably prepared through the first part (including the supply part and the compression part) before the extrusion screws and the second part (kneading part) after the extrusion screws as described below.

In the first part (including the supply part and the compression part; hereinafter referred to as “the first process”), the degradable resin is melted, and the starch is gelatinized. While gas, moisture, and the like are being discharged from an open vent to prevent the backflow caused by the increased pressure in the extruder, it is preferable to complete the melting of the degradable resin and the gelatinization of starch by heating and mixing.

In the second part (kneading part; hereinafter referred to “the second process”), the degradable resin is mixed with the gelatinized starch, and water is discharged. Preferably, the degradable resin is further mixed with the gelatinized starch while water is being discharged from the vacuum vent.

In the first process, corresponding to the softening temperature (or the melting point) of the degradable resin, the set temperature is typically from about 60 to about 160° C., preferably from 80 to 150° C., more preferably from 100 to 140° C. Since most of the degradable resins are softened (or melt) in such temperature ranges, the gelatinized starch is mixed with the melt degradable resin at the same time when an oxidized starch is gelatinized.

The residence time in the first process is typically from 30 to 180 seconds, preferably from 60 to 120 seconds. When the residence time is 30 seconds or more, the starch is sufficiently gelatinized. When the residence time is 180 seconds or less, the degradation of the degradable resin can be suppressed to ensure the productivity.

The starch gelatinization in the first process requires water. Moisture contained in the starch itself alone may be enough for the gelatinization depending on the temperature, the residence time, the shear force, and the like. However, a necessary amount of water, polar solvent with a high boiling point, and the like can be added so as to complete the gelatinization.

Examples of the polar solvent include ethylene glycol, propylene glycol, glycerin, sorbitol, polyethylene glycol, and polypropylene glycol. Among these, glycerin is preferably used in terms of compatibility between the starch and the degradable resin, gelatinization properties, and cost effectiveness.

In the second process, the set temperature is typically from about 130 to about 180° C., preferably from 135 to 175° C., more preferably from 140 to 170° C. Through this process, the degradable resin is completely melt-mixed with the gelatinized starch.

In the second process, one or more vent holes can be provided to remove water or to adjust the water content in the resultant resin composition.

The residence time in the second process is typically from 30 to 120 seconds, preferably from 60 to 90 seconds. When the residence time is 30 seconds or more, the degradable resin is sufficiently mixed with the gelatinized starch. When the residence time is 120 seconds or less, the degradation of the degradable resin can be suppressed to ensure the productivity.

Therefore, the above-mentioned method can provide a resin composition containing a degradable resin and a starch. Even when unprocessed starch or processed starch such as oxidized starch is used as the starch, a resin composition containing a degradable resin and a starch is obtained under the same conditions.

If a large amount of water is contained in the resultant resin composition because of the moisture of in the starch, the water added to completely gelatinize starch, or the moisture absorbed from air during the storage, the resultant resin composition may foam while being formed into a film to cause inhomogeneous surfaces of the film, even worse holes in the film. Thus, the water content of the above-mentioned resin composition or pellets thereof is preferably 4,000 ppm by mass or less, more preferably 3,000 ppm by mass or less.

The method of removing the water from the resin composition or pellets thereof is, but not particularly limited to, preferably heat-drying at from 50 to 100° C. In the heat-drying, hot wind may not circulate in a dryer, but in order to accelerate the drying, a dehumidified air-circulation dryer, a fluidized bed dryer, and the like are preferable because hot wind is generated to circulate in these dryer.

<Preferred Aspect (1): Particle with an Average Particle Size of 1 mm or Less>

The particles with an average particle size of 1 mm or less as the preferred aspect (1) of the injection material for fracturing can be produced by melt-kneading the degradable resin with the starch to obtain the pellets or the formed products of the resin composition and then pulverizing the pellets or the formed products.

The methods of pulverizing the pellets or the formed products are not limited in particular. However, the typical pulverization method is likely to lead to thermal denaturation of the degradable resin and the like due to heat generation during the pulverization. In the low-temperature pulverization, the degradable resin becomes brittle at a low-temperature and finely pulverized with the heat generation being suppressed not to cause thermal denaturation. Among low-temperature pulverizing techniques, freeze-pulverization is particularly preferable.

Freeze-pulverization can be typically performed with an impact pulverizer such as Lynrex Mill (a trademark), a pin mill, a hammer mill, a disk mill, a ball mill, and a turbo mill after cooling the pellets or the formed products down to a brittle point or less under liquid nitrogen atmosphere. Among these pulverizers, Lynrex Mill is more preferable.

Lynrex Mill (a trademark) is provided with a liner fixed to the outer edge of mill with a great number of sharp parts and a plate with a plurality of blades. The rotary shaft of the plate is typically disposed in the center of Lynrex Mill. An impact is made between the blades fixed to the plate and the liner to pulverize the pellets. The size of Lynrex Mill, the size of the plate, the number of rotation of the plate, the number of blades fixed to the plate, and the like are appropriately selected. Examples of Lynrex Mill include Cryogenic Grinding Unit “Lynrex Mill” LX series commercially available from Hosokawa Micron Corp. Furthermore, Lynrex Mill may be provided with a classification mechanism.

Preferably, the pellets and the formed products are pulverized to have an average particle size of preferably 1 mm or less, more preferably 0.9 mm or less, further more preferably 0.8 mm or less, particularly preferably 0.5 mm or less in view of rapidly degrading the degradable resin and in view of smoothly sliding into a support material into fractures.

The average particle size of the pulverized pellet material can be measured with a classifier equipped with a fixed mesh and a vibrating air column, “Micron Washieve” commercially available from Hosokawa Micron Corp.

Furthermore, particles with an average particle size of 1 mm or less can be directly prepared by making a size of the pellet smaller or by suspension polymerization or the like instead of the above-mentioned pulverization method.

### <Preferred Aspect (2): Microfilm>

The microfilm as the preferred aspect (2) of the injection material for fracturing can be produced by melt-kneading the degradable resin and the starch to obtain a resin composition, forming the resin composition into a film such as an inflation film, and pulverizing the film.

The injection material for fracturing of the present invention is more preferably in the form of a pulverized film material in view of reducing the sedimentation of the fracture support material in the fracturing fluid to uniformly deliver the fracturing fluid deep into fractures (cracks) and in view of easily blending with other components.

The resin composition at least containing a degradable resin and a starch is formed into a film by, for example, inflation molding and T-die type film formation and the like, but inflation molding is preferable. In the formation of the resin composition into a film, a plasticizer may be further added.

The plasticizer is preferably a glycerin derivative, particularly preferably polyglycerol acetic acid ester or a derivative thereof, or adipic acid diester.

The additive amount of the plasticizer is typically from 1 to 10 parts by mass, preferably from 2 to 8 parts by mass, based on 100 parts by mass of the total amount of the degradable resin composition, i.e., the degradable resin and the starch. When the additive amount is 1 part by mass or more, the physical properties of a film, particularly the tensile elongation and the impact strength of a film are improved. When the additive amount is 10 parts by mass or less, a plasticizer is prevented from bleeding out.

Furthermore, unless the present invention loses its own feature, the film of the injection material for fracturing can optionally contain an additive typically used in the technical field of the present invention, such as an antioxidant, a thermal stabilizer, an ultraviolet absorber, an antistat, a flame retardant, a crystallization accelerator, and a filler.

Examples of the antioxidant include hindered phenolic antioxidants such as p-t-butylhydroxytoluene and p-t-butylhydroxyanisole. Examples of the thermal stabilizer include triphenyl phosphite and tris(nonylphenyl)phosphite.

Examples of the ultraviolet absorber include p-t-butylphenyl salicylate, 2-hydroxy-4-methoxybenzophenone, 2-hydroxy-4-methoxy-2′-carboxybenzophenone, and 2,4,5-trihydroxybutyrophenone. Examples of the antistat include N,N-bis(hydroxyethyl) alkylamines, alkylamines, alkyl aryl sulfonates, and alkyl sulfonates.

Examples of the flame retardant include hexabromocyclododecane, tris-(2,3-dichloropropyl)phosphate and pentabromophenyl allyl ether. Examples of the crystallization accelerator include talc, boron nitride, polyethylene terephthalate, and poly-transcyclohexanedimethanol terephthalate. Examples of the filler include inorganic fillers such as clay, talc, and sodium carbonate; and organic fillers such as cellulose powders, cotton powders, and wood powders.

### (Inflation Molding)

As described above, the film can be prepared by inflation molding, T-die type film formation, and the like, but a preferred example of inflation molding will be described below.

The extrusion screw of an inflation molding machine is preferably of a full flight moderate-compression type in view of suppressing the heat generation when the degradable resin is melt-kneaded with the starch.

The extrusion barrel (cylinder) of the inflation molding machine preferably has no irregularities or welding joints but high straightness.

The effective length of the extruder screw (screw length (L)/screw diameter (D)) is typically from 10 to 40, preferably from 20 to 40, more preferably from 25 to 40.

The compression ratio (C/R) of the screw is typically 2.5 or less, preferably 2.0 or less, more preferably 1.8 or less. The compression ratio is also preferably 1.2 or more, more preferably 1.4 or more.

The blow-up ratio (film diameter/die diameter) of the inflation molding is typically from 2 to 8, preferably from 2.3 to 6, more preferably 2.5 to 5.

The lip-gap of the ring dice is preferably from 1.0 to 2.0 mm, more preferably from 1.0 to 1.8 mm, further more preferably from 1.1 to 1.5 mm, particularly preferably from 1.1 to 1.4 mm in view of stably performing the inflation molding of the resin composition containing a degradable resin and a starch and in view of improving the physical properties of a film.

The temperature of the ring dice is typically from about 130 to about 180° C., preferably from 145 to 170° C.

The airing of the inflation molding is preferably of a multi-layered vertical flow type because the above-mentioned mixture has a low crystallization temperature and a low melt tension.

In inflation molding, the resin composition containing a degradable resin and a starch can be optionally blended with a certain amount of dispersant, colorant, surfactant, pH adjuster, deoxidant, glycerin, polyethylene glycol, cross-linker, flame retardant, aromatic substance, weathering stabilizer, and the like.

Instead of preparing the resin composition containing a degradable resin and a starch followed by the film as described above, the pelletized or flaked resin composition containing a degradable resin and a starch can be used to prepare the film at a set temperature within the same range in the above-mentioned second process, i.e., at from about 130 to about 180° C., preferably from 145 to 170° C. in the inflation molding machine or the T-die type film extruder.

The film of the resin composition containing a degradable resin and a starch may be further uniaxially or biaxially-extended.

The thickness of the inflation film obtained above is preferably from 5 to 200 μm, more preferably from 5 to 150 μm, further more preferably from 5 to 120 μm, particularly preferably from 10 to 100 μm in view of stably forming a film.

### (Pulverizing of Film)

The method of pulverizing the inflation film obtained above is not limited in particular. A rotary cutter is preferably used to finely pulverize the film.

The rotary cutter is a pulverizer (shredder) with two to five fixed blades and three to ten single-edged rotary blades. This rotary cutter shreds the film with supplying air so as to pulverize while maintaining the hard film state without shears or crinkles. This enables the film to pulverize with suppressing the generation of curls and the like to increase bulk specific gravity.

Examples of a commercially available rotary cutter preferably include RC series rotary cutters (thin material pulverizers) available from Yoshikoh Co., Ltd.

In the rotary cutter, a rotary blade is attached in the chamber, and a mesh with an opening of, for example, from 0.5 to 15 mm, preferably from 1 to 10 mm, more preferably from 1 to 8 mm, further more preferably from 2 to 6 mm is attached to the bottom of the chamber to eliminate pulverized material with a median value within a predetermined range. As a result, only pulverized material with a size larger than a predetermined size is further continuously pulverized. In a preferred embodiment, the film is formed into fragments with a width of from about 0.1 to about 10 mm and a length of from about 0.1 to about 10 mm, and the fragments are put in the chamber and pulverized, for example, for from about 2 to about 30 minutes. While the pulverized material with a size smaller than a predetermined value passes through the mesh at the bottom of the chamber and recovered outside the system, the other material not passing through the mesh is further continuously pulverized. As a result, pulverized film material with a trace amount of large pieces is obtained. The resultant pulverized film material can provide a homogeneous fracturing fluid after mixed with a fracture support material with an average particle size of from 0.1 to 3 mm.

Furthermore, the particle size of the pulverized film material can be measured with a ro-tap sieve shaker commercially available from Sieve Factory Iida Co., Ltd.

As a ratio (longitudinal length (L)/lateral length (D)) of the pulverized film material is larger, the pulverized film material more easily blends with other components to hardly cause phase separation. Thus, the aspect ratio of the pulverized film material is typically 1 or more, preferably 4 or more, more preferably 6 or more, further more preferably 10 or more.

The aspect ratio can be adjusted by changing the number of cutter blades in the preparation of the pulverized film material. In other words, due to the constant width and the drawing speed of the film, the number of cutter blades is increased to decrease the aspect ratio while the number of cutter blades is decreased to increase the aspect ratio.

In the measurement of the aspect ratio (LID), the longest part of the pulverized film material represents the longitudinal length (L), and the longest part perpendicular to the longitudinal length (L) represents the lateral length (D).

The aspect ratio can be measured with a non-contact surface shape measuring device “NewView 7300” commercially available from Canon Inc.

### [Fracturing Fluid]

The fracturing fluid of the present invention contains the above-mentioned injection material for fracturing of the present invention, a fracture support material with an average particle size of from 0.1 to 3 mm, and water.

The injection material for fracturing contained in the fracturing fluid of the present invention improves the dispersibility of the fracture support material and help deliver the fracturing fluid. The water is a main fluid of the fracturing fluid.

The content of the injection material for fracturing in the fracturing fluid is preferably from 0.00001 to 0.1 mass %, more preferably from 0.0001 to 0.1 mass %, further more preferably from 0.001 to 0.1 mass %, particularly preferably from 0.001 to 0.05 mass %.

### <Fracture Support Material>

The fracture support material (hereinafter merely referred to as “support material”) supports the fractures created by applying pressure to extraction layers deep underground to prevent the fractures from closing.

The support material preferably forms a particle with an average particle size of from 0.1 to 3 mm larger than the size of the soil in extraction layers deep underground. The average particle size of the support material is preferably from 0.1 to 2.8 mm, more preferably from 0.2 to 2.0 mm, further more preferably from 0.4 to 1.5 mm. The size of the support material may be non-uniform but preferably uniform to be introduced deep into the formed fractures.

The support material receives closure pressure from the fracture surface. And thus, the fracture should not be crushed to avoid the support material to sink into the layers. Thus, the strength of the support material is preferably 350 kgf/cm² or more, more preferably 400 kgf/cm² or more, per particle. Furthermore, the support material preferably has chemical-resistance. As such, the source material of the support material is preferably silica sand, sand, glass beads, ceramic, or the like.

The support material may be used as is. However, the support material is preferably coated with thermosetting epoxy resin, urea resin, phenol resin, furan resin, or the like in view of preventing the support material from being fractionated by the closure pressure of fractures not to reduce the function of the support material and in view of improving the fluid conductance by smoothing the surface of the support material.

The content of the support material in the fracturing fluid is preferably from 1 to 20 mass %, more preferably from 2 to 18 mass %, further more preferably from 3 to 15 mass %.

### <Other Additives>

In view of easily injecting the fracturing fluid, the fracturing fluid of the present invention can further optionally contain additives, for example, an acid dissolving minerals (e.g., hydrochloric acid), a biocide preventing bacterial corrosion (e.g., glutaraldehyde, ethanol, methanol), a breaker reducing the viscosity of the polymer not to close the fractures in extraction layers deep underground (e.g., ammonium persulfate), a corrosion inhibitor (e.g., N, N-dimethylformaldehyde), a cross-linker maintaining the viscosity during the increasing of the temperature (e.g., borate), a friction reducer reducing the friction loss to easily inject the fracturing fluid (e.g., polyacrylamide, mineral oil, fibrous substances), a gelator improving the concomitance of the fracture support material (e.g., guar gum, hydroxyethyl cellulose), an iron control agent preventing metal oxides from precipitation (e.g., citric acid), a clay swelling inhibiter (e.g., potassium chloride), a pH adjustor (e.g., sodium carbonate), a scale inhibitor preventing scale/sludge from adhering to the inside of the pipes due to the water-insolubility (e.g., ethylene glycol), and a thickener (e.g., isopropanol).

The additive amount of the above-mentioned additives in the fracturing fluid is typically from 0.0001 to 1%, preferably from 0.0005 to 1%, more preferably from 0.001 to 1%.

### EXAMPLES

The invention will be described in detail below with reference to the examples and the comparative examples but not limited thereto. The physical properties were measured by the following methods.

### (1) Measurement of Particle Size of Pulverized Pellet Material

The average particle size of the pulverized pellet material was measured with the classifier equipped with a fixed mesh and a vibrating air column, “Micron Washieve WST-1” commercially available from Hosokawa Micron Corp.

### (2) Measurement of Particle Size of Pulverized Film Material

The particle size of the pulverized film material was measured with a ro-tap sieve shaker commercially available from Sieve Factory Iida Co., Ltd.

### (3) Measurement of Aspect Ratio of Pulverized Film Material

The aspect ratios were measured with a non-contact surface shape measuring device “NewView 7300” commercially available from Canon Inc.

### Preparation Example 1

### (1) Preparation of Degradable Resin-Containing Film

60 mass % of the “Bionolle (a trademark) 3001MD” (aliphatic polyester; polycondensate of succinic acid and adipic acid with 1,4-butanediol, MFR: 1 g/10 min (temperature: 190° C., load: 2160 g)) commercially available from Showa Denko K. K. and 40 mass % of unprocessed cornstarch were prepared as the degradable resin and the starch, respectively.

The degradable resin were mixed with the starch with a super mixer, melt-kneaded with a co-rotating twin-screw extruder equipped with a vent for dewatering (screw diameter: 80 mm, effective length (L/D): 32) to provide pellets of the degradable composition resin. The melt-kneading conditions of the twin-screw extruder were 130° C. and a residence time of 70 seconds in the first part (including the supply part and the compression part), and 140° C. and a residence time of 70 seconds in the second part (kneading part).

The resultant pellets as raw material were formed into an inflation film with a thickness of 15 μm with an inflation molding machine commercially available from Placo Co., Ltd. in accordance with the following conditions.

The lip gap is 1.2 mm, the blow-up ratio is 3, the screw is of a full flight moderate-compression type, the effective length of the screw (L/D) is 28, the compression ratio of the screw (C/R) is 1.5, the die is a diameter of 150 mmφ, the motor power is 22 kW, the blower power is 7.5 kW, the airing is of a double-layered vertical flow type (HA300, commercially available from Placo Co., Ltd.), the molding temperature is 165° C.

### (2) Film Formability Test

The inflation film obtained by the above-mentioned (1) was subjected to inflation film molding. The film formability was evaluated in accordance with the following criteria. The result is shown in Table 1.

### Evaluation Criteria

Excellent: The film was stably formed without uneven thickness.

Good: The film was stably formed but with a slightly uneven thickness not causing a practical problem.

Average: The film was stably formed with an uneven thickness.

Poor: The film was not formed.

### Preparation Examples 2 to 5

The same operation as Preparation Example 1 was performed except for changing the starch of Preparation Example 1 to those shown in Table 1. The result is shown in Table 1.

The starches shown in Table 1 are described in detail below.

Cornstarch: trade name “Cornstarch”, commercially available from Oji Cornstarch Co., Ltd., substitution degree of carboxyl group: 0, viscosity (Brabender viscosity): 1100±50 BU measured at a concentration of 8 mass % at 50° C. 1 hour after heated, moisture: 12 mass % (ordinary temperature heating method at 105° C. for 4 hours).

Oxidized starch: trade name “Ace A”, commercially available from Oji Cornstarch Co., Ltd., substitution degree of carboxyl group: 0.01, viscosity (Brabender viscosity): 300±50 BU measured at a concentration of 20 mass % at 50° C. 1 hour after heated, moisture: 12 mass % (ordinary temperature heating method at 105° C. for 4 hours).

Esterified starch: trade name “Ace P130”, commercially available from Oji Cornstarch Co., Ltd., viscosity (Brabender viscosity): 200±50 BU measured at a concentration of 20 mass % at 50° C. 1 hour after heated, moisture: 12 mass % (ordinary temperature heating method at 105° C. for 4 hours).

Acetylated starch: trade name “Ace OSA1100”, commercially available from Oji Cornstarch Co., Ltd.

Cationized starch: trade name “Ace K100”, commercially available from Oji Cornstarch Co., Ltd., viscosity (Brabender viscosity): 200±50 BU (measured at a concentration of 6 mass % at 50° C. 1 hour after heated), moisture: 12 mass % (ordinary temperature heating method at 105° C. for 4 hours).

The Brabender viscosity was measured with a Brabender viscometer available from Brabender GmbH & Co. KG after a starch slurry adjusted to a predetermined concentration was set in the viscometer, heated to 95° C., left for 30 minutes, cooled to 50° C., and left again for 30 minutes.

TABLE 1

| | | Preparation Examples | | | | |
|---|---|---|---|---|---|---|
| | | 1 | 2 | 3 | 4 | 5 |
| Degradable | Type*¹ | 3001MD | 3001MD | 3001MD | 3001MD | 3001MD |
| Resin | mass % | 60 | 60 | 60 | 60 | 60 |
| Starch | Type | Cornstarch | Oxidized starch | Esterified | Acetylated | Cationized |
| | | | | starch | starch | starch |
| | mass % | 40 | 40 | 40 | 40 | 40 |

| | | | | | |
|---|---|---|---|---|---|
| Film Formability | Good | Excellent | Good | Good | Good |

*¹Bionolle (a trademark) 3001MD: aliphatic polyester commercially available from Showa Denko K. K.

Table 1 shows that the inflation films obtained in Preparation Examples 1 to 5 have excellent formability.

### Preparation Examples 6 to 8 and Comparative Preparation Example 1

### (1) Preparation of Film Containing Degradable Resin

Pellets of the degradable resin composition was obtained by use of the biodegradable resin “Bionolle (a trademark) 3001MD,” commercially available from Showa Denko K. K. and the oxidized starch “Ace A” commercially available from Oji Cornstarch Co., Ltd. in the same manner as Preparation Example 1. The melt-kneading conditions of the twin-screw extruder were 120° C. and a residence time of 80 seconds in the first part (including the supply part and the compression part), and 160° C. and a residence time of 80 seconds in the second part (kneading part).

### (2) Film Formability Test

The pellets obtained by the above-mentioned (1) were subjected to inflation film molding to evaluate the film formability in the same manner as Preparation Example 1.

### (3) Film Degradability Test

The degradability of the film obtained in the above-mentioned (2) was tested in an agricultural experiment station located in Omitama-shi, Ibaraki, Japan.

The film was buried at a depth of 10 cm below ground. And, 1 week after buried, the film was taken out, weighed. The film degradability was evaluated in accordance with the following criteria. The result is shown in Table 2.

### Evaluation Criteria:

Poor: The mass reduction is less than 10%.

Average: The mass reduction is 10% or more and less than 20%.

Good: The mass reduction is 20% or more.

TABLE 2

| | | | | | Com- |
|---|---|---|---|---|---|
| | | | | | parative |
| | | | | | Prepa- |
| | | | | | ration |
| | | Preparation Examples | | | Example |
| | | 6 | 7 | 8 | 1 |
| Degrad- | Type*¹ | 3001MD | 3001MD | 3001MD | 3001MD |
| able | mass % | 90 | 60 | 40 | 100 |
| Resin | | | | | |
| Starch | Type | Oxidized | Oxidized | Oxidized | Oxidized |
| | | starch | starch | starch | starch |
| | mass % | 10 | 40 | 60 | 0 |
| Film formability | | Excellent | Excellent | Good | Excellent |
| Degrada- | Degradation | 7 | 4 | 3 | 10 |
| bility | Days | | | | |
| | Evaluation | Good | Good | Good | Poor |

*¹Bionolle (a trademark) 3001MD: aliphatic polyester commercially available from Showa Denko K. K.

Table 2 shows that the inflation films obtained in Preparation Examples 6 to 8 have good formability and excellent degradability.

### Example 1

### Production and Evaluation of Injection Material for Fracturing

### (1) Preparation of Pulverized Material-Containing Degradable Resin

The biodegradable resin “Bionolle (a trademark) 3001MD” commercially available from Showa Denko K. K. and the oxidized starch “Ace A” commercially available from Oji Cornstarch Co., Ltd. were prepared as the degradable resin and as the starch, respectively.

Pellets were prepared from the degradable resin and the starch in the same manner as Preparation Example 1. The melt-kneading conditions of a twin-screw extruder were 130° C. and a residence time of 70 seconds in the first part (including the supply part and the compression part), and 170° C. and a residence time of 70 seconds in the second part (kneading part).

The resultant pellets were freeze-pulverized with a low-temperature pulverizing machine “Lynrex Mill” commercially available from Hosokawa Micron Corp. and classified to obtain material with an average particle size of 0.7 mm.

### (2) Degradability Test of Pulverized Material

The degradability of the pulverized material obtained in the above-mentioned (1) was evaluated in the same manner as Product Examples 6 to 8 (3). The result is shown in Table 3.

### Examples 2 to 6 and Comparative Example 1

### Preparation and Evaluation of Injection Material for Fracturing

The same operation as Example 1 was performed except for changing the conditions of Example 1 to those shown in Table 3. The result is shown in Table 3.

TABLE 3

| | | | | | | | | Comparative |
|---|---|---|---|---|---|---|---|---|
| | | Examples | | | | | | Example |
| | | 1 | 2 | 3 | 4 | 5 | 6 | 1 |
| Degradable Resin | Type*¹ | 3001MD | 3001MD | 3001MD | 3001MD | 3001MD | 3001MD | 3001MD |
| | mass % | 10 | 40 | 60 | 90 | 95 | 50 | 100 |
| Starch | Type | Oxidized | Oxidized | Oxidized | Oxidized | Oxidized | Oxidized | Oxidized |
| | | starch | starch | starch | starch | starch | starch | starch |
| | mass % | 90 | 60 | 40 | 10 | 5 | 50 | 0 |
| Average Particle Size | mm | 0.7 | 0.8 | 0.9 | 0.8 | 0.9 | 1.5 | 0.7 |
| of Pulverized Material | | | | | | | | |

| | | | | | | | |
|---|---|---|---|---|---|---|---|
| Degradability | Good | Good | Good | Good | Good | Average | Poor |

*¹Bionolle (a trademark) 3001MD: aliphatic polyester commercially available from Showa Denko K. K.

Table 3 shows that the pulverized materials (injection material for fracturing) obtained in Examples 1 to 6 have excellent degradability at the time of being buried below the ground.

### Example 7 to 12

### Production and Evaluation of Injection Material for Fracturing

The biodegradable resin “Bionolle (a trademark) 3001MD” commercially available from Showa Denko K. K. and the polylactic acid “Ingeo 4060D” (D-lactic acid content: 12 mol %, MFR: 2.3 g/10 min (190° C., 2160 g), the weight-average molecular weight: 200,000) commercially available from Nature Works LLC and the oxidized starch “Ace A” commercially available from Oji Cornstarch Co., Ltd. were prepared as the degradable resins and the starch, respectively.

With a film thicknesses varied from 5 to 200 μm as shown Table 4, inflation molding was performed in the same manner as Preparation Example 1 to evaluate the film formability. The result is shown in Table 4.

TABLE 4

| | | Examples | | | | | |
|---|---|---|---|---|---|---|---|
| | | 7 | 8 | 9 | 10 | 11 | 12 |
| Degradable | Type*¹ | 3001MD | 3001MD | 3001MD | 3001MD | 3001MD | 3001MD |
| Resin | mass % | 50 | 50 | 50 | 50 | 50 | 50 |
| | Type*² | Polylactic | Polylactic | Polylactic | Polylactic | Polylactic | Polylactic |
| | | acid | acid | acid | acid | acid | acid |
| | mass % | 20 | 20 | 20 | 20 | 20 | 20 |
| Starch | Type | Oxidized | Oxidized | Oxidized | Oxidized | Oxidized | Oxidized |
| | | starch | starch | starch | starch | starch | starch |
| | mass % | 30 | 30 | 30 | 30 | 30 | 30 |
| Film | μm | 5 | 8 | 15 | 40 | 100 | 200 |
| Thickness | | | | | | | |

| | | | | | | |
|---|---|---|---|---|---|---|
| Film Formability | Good | Good | Excellent | Excellent | Excellent | Good |

*¹Bionolle (a trademark) 3001MD: aliphatic polyester commercially available from Showa Denko K. K.
*²Ingeo 4060D: polylactic acid commercially available from Nature Works LLC

Table 4 shows that Examples 7 and 8 stably formed a film but with an uneven thicknesses. Examples 9 to 11 formed a film without an uneven thickness.

Example 12 formed a film with an uneven thickness because insufficiently cooling the film to cause unstable bubbling.

### Examples 13 to 16

### Production and Evaluation of Fracturing Fluid

(1) After the Biodegradable Resin “Bionolle (a Trademark) 3001MD” commercially available from Showa Denko K. K. and the oxidized starch “Ace A” commercially available from Oji Cornstarch Co., Ltd. were prepared as the raw materials, inflation molding was performed with an inflation molding machine commercially available from Placo Co., Ltd. to provide an inflation film in the same manner as Examples 7 to 12.

The resultant inflation film was pulverized with a rotary cutter (thin material pulverizer) RC-250 commercially available from Yoshikoh Co., Ltd to provide pulverized film material with a thickness of 15 μm. At the chamber bottom of the rotary cutter, a mesh with a predetermined opening shown in Table 5 was attached to obtain pulverized film material shown in Table 5. This pulverized film material was classified to obtain various aspect ratios.

### (2) Evaluation of Dispersion Condition of Fracturing Fluid

The pulverized film material shown in Table 5 was used to produce fracturing fluid with the composition described below. The fracturing fluid was poured into a transparent water tank and stirred. After 5 minutes, while stirring the dispersion condition was visually observed and evaluated as described below. The result is shown in Table 5.

| Composition of Fracturing Fluid | mass % |
|---|---|
| Sand (fracture support material) | 8.96 |
| Hydrochloric acid (mineral-dissolving agent) | 0.11 |
| Glutaraldehyde (biocide) | 0.001 |
| Ammonium persulfate (breaker) | 0.01 |
| N,N-dimethylformaldehyde (corrosion inhibitor) | 0.001 |
| Borate (cross-linker) | 0.01 |
| Polyacrylamide and mineral oil (friction reducer) | 0.08 |
| Guar gum and hydroxyethyl cellulose (gelator) | 0.05 |
| Citric acid (iron control agent) | 0.004 |
| Potassium chloride (clay swelling inhibiter) | 0.05 |
| Sodium carbonate (pH adjuster) | 0.01 |
| Ethylene glycol (scale inhibitor) | 0.04 |
| Isopropanol (thickener) | 0.08 |
| Pulverized film material (injection material for fracturing) | 0.01 |
| Water (main fluid) | 90.584 |
| Total | 100.000 |

### (Criteria for Evaluating Dispersion Condition)

Excellent: The components were well dispersed and not aggregated, not attached to the surface of the tank wall, not sedimented on the bottom of the tank, and not floated on the surface of the water.

Good: The components were well dispersed and not attached to the surface of the tank wall, not sedimented on the bottom of the tank, and not floated on the surface of the water, but partially aggregated.

Average: The components were well dispersed and not attached to the surface of the tank wall, and not sedimented on the bottom of the tank, but floated on the surface of the water and partially aggregated, without causing a practical problem.

Poor: The components were inhomogeneously dispersed and aggregated, attached to the surface of the tank wall, sedimented on the bottom of the tank, and floated on the surface of the water.

TABLE 5

| | | Examples | | | |
|---|---|---|---|---|---|
| | | 13 | 14 | 15 | 16 |
| Degradable | Type*¹ | 3001MD | 3001MD | 3001MD | 3001MD |
| Resin | mass % | 60 | 60 | 60 | 60 |
| Starch | Type | Oxidized | Oxidized | Oxidized | Oxidized |
| | | starch | starch | starch | starch |
| | mass % | 40 | 40 | 40 | 40 |
| Sieve Opening | mm | 0.5 | 4 | 6 | 12 |
| Size | | | | | |

| | | | | |
|---|---|---|---|---|
| Dispersion Condition | Average | Excellent | Excellent | Average |

*¹Bionolle (a trademark) 3001MD: aliphatic polyester commercially available from Showa Denko K. K.

Table 5 shows that the fracturing fluids obtained in Examples 13 to 16 have excellent dispersion stability and sufficient practicality.

### Examples 17 to 21

### Production and Evaluation of Fracturing Fluid

After the biodegradable resin “Bionolle (a trademark) 3001MD” commercially available from Showa Denko K. K., the polylactic acid “Ingeo 4060D” commercially available from Nature Works LLC, and the oxidized starch “Ace A” commercially available from Oji Cornstarch Co., Ltd. were prepared as the degradable resins and the starch, respectively, inflation molding was performed with an inflation molding machine commercially available from Placo Co., Ltd. to provide an inflation film in the same manner as Example 9.

The resultant inflation film was pulverized with a rotary cutter (thin material pulverizer) RC-250 commercially available from Yoshikoh Co., Ltd to provide pulverized film material with a thickness of 15 μm. This pulverized film material was classified to obtain various aspect ratios.

Fracturing fluids with the same composition as Examples 13 to 16(2) were prepared from the resultant pulverized film material with various aspect ratios to evaluate in the same manner as Examples 13 to 16(2). The result is shown in Table 6.

TABLE 6

| | | Examples | | | | |
|---|---|---|---|---|---|---|
| | | 17 | 18 | 19 | 20 | 21 |
| Degradable Resin | Type*¹ | 3001MD | 3001MD | 3001MD | 3001MD | 3001MD |
| | mass % | 50 | 50 | 50 | 50 | 50 |
| | Type*² | Polylactic | Polylactic | Polylactic | Polylactic | Polylactic |
| | | acid | acid | acid | acid | acid |
| | mass % | 20 | 20 | 20 | 20 | 20 |
| Starch | Type | Oxidized | Oxidized | Oxidized | Oxidized | Oxidized |
| | | starch | starch | starch | starch | starch |
| | mass % | 30 | 30 | 30 | 30 | 30 |
| Sieve Opening Size | mm | 0.5 | 2 | 4 | 4 | 8 |
| Aspect Ratio of | longitudinal length/ | 1 | 4 | 5 | 10 | 20 |
| Pulverized Material | lateral length | | | | | |

| | | | | | |
|---|---|---|---|---|---|
| Dispersion condition | Average | Good | Good | Excellent | Excellent |

*¹Bionolle (a trademark) 3001MD: aliphatic polyester commercially available from Showa Denko K. K.
*²Ingeo 4060D: polylactic acid commercially available from Nature Works LLC

Table 6 shows that the fracturing fluids obtained in Examples 17 to 21 have excellent dispersion stability and sufficient practicality.

### INDUSTRIAL APPLICABILITY

The present invention can provide a fracturing fluid capable of shortening the construction period due to the high level of safety, the excellent dispersion stability of a fluid and a fracture support material, and the short-term degradability and also provide an injection material for fracturing to be contained in the fracturing fluid.

The injection material for fracturing and the fracturing fluid of the present invention are industrially advantageous because controlling the degradability with superiority in environmental protection.

1. An injection material for fracturing, comprising a resin composition at least containing a hydrolyzable or biodegradable resin and a starch.

2. The injection material for fracturing according to claim 1, wherein the starch is oxidized starch.

3. The injection material for fracturing according to claim 1, wherein the hydrolyzable or biodegradable resin is one or more selected from polybutylene succinate, polybutylene succinate-adipate, polybutylene adipate-terephthalate, and polylactic acid.

4. The injection material for fracturing according to claim 1, wherein the injection material for fracturing is a pulverized material formed from a formed product of the resin composition containing a hydrolyzable or biodegradable resin and a starch.

5. The injection material for fracturing according to claim 1, wherein the resin composition forms a particle with an average particle size of 1 mm or less.

6. The injection material for fracturing according to claim 4, wherein the pulverized material formed from the formed product is a microfilm with a thickness of from 5 to 200 μm.

7. The injection material for fracturing according to claim 6, wherein the microfilm is a fraction passed through a sieve with an opening of from 0.5 to 15 mm.

8. The injection material for fracturing according to claim 6, wherein the aspect ratio (longitudinal length/lateral length) of the microfilm is 4 or more.

9. The injection material for fracturing according to claim 1, wherein the amount of the starch is from 5 to 90 mass % based on the total amount of the hydrolyzable or biodegradable resin and the starch.

10. A fracturing fluid comprising the injection material for fracturing according to claim 1, a fracture support material with an average particle size of from 0.1 to 3 mm, and water.
